(19) United States
(12) Patent Application Publication
(10) Pub. No.: US 2014/0314738 A1
(43) Pub. Date: Oct. 23, 2014

(54) DISINFECTING COMPOSITION

(71) Applicant: YA-CHUNG WEI, TAOYUAN COUNTY (TW)

(72) Inventor: YA-CHUNG WEI, TAOYUAN COUNTY (TW)

(21) Appl. No.: 13/865,998

(22) Filed: Apr. 18, 2013

(51) Int. Cl. A01N 43/16; A01N 37/36; A01N 59/00

(52) U.S. Cl. CPC A01N 43/16; A01N 59/00; A01N 37/36
USPC 424/126; 424/616; 514/23; 514/55

(57) ABSTRACT

A disinfecting composition comprises chitosan and peroxycarboxylic acid. The weight ratio of chitosan to peroxycarboxylic acid is from 0.01-100. Chitosan is selected from the group consisting of amino monosaccharide, acetylamino monosaccharide, chitooligosaccharide, chitosan polymer and the combination thereof, and peroxycarboxylic acid is a C1-C18 aliphatic peroxycarboxylic acid that is selected from the group consisting of peroxy monocarboxylic acid, peroxy dicarboxylic acid and the combination thereof.

### BACKGROUND

1. Field of the Invention

The invention relates to disinfecting compositions. In particular, it relates to disinfectants for providing microbicidal efficacy in various materials such as natural products, artificial products, and living bodies against the contamination of microorganisms.

2. Description of Related Art

Any article, either a livelihood or an inanimate substrate, exposed to the atmosphere is inevitable to attach microbes and to be a medium for growing microorganisms including bacteria and fungi. Some microbes are pathogenic which can cause disease in human, animal and plant, injury public health, and hurt the environmental sanitary. On the going growth and metabolism, microbes produce acidic chemicals and odorous smells which lead to material ageing and breakdown and to air pollution. Most microorganisms are colored, thus the generated colorant may leave contaminated stains on material surface and causes poor appearance. It is therefore essential to protect materials and products from the damage of microbes by applying suitable disinfectant. Disinfection is the removal of organisms in a material or on an object. In principle, agents for removing organisms or controlling microbial growth can be categorized into antimicrobials, disinfectants and sanitizers according to their action mode and the rate. There have been a variety of agents in practice for disinfection, which are divided into three groups including the inorganic, organic and natural agents, by their sources and chemical constitution. Conventionally, toxicity is a persisting problem in chemical disinfecting agents including inorganic and organic compounds, particularly the high effective chemicals such as halides, heavy metals, aldehyde and phenol. After killed or removed microorganisms in environment, these disinfectants may leave over persistent toxic or mutagenic residuals in the air and on the surface of objects that are harmful to animals and human beings.

Chitosan is an abundant natural polymer which is an amino-polysaccharide obtained from the recycle of shell waste of sea crustaceans. Chitosan has been proved to exhibit microbicidal activity. The testing reports indicate that chitosan can effectively and broadly inhibit the growth of microbes including bacteria, fungi, yeast and algae. The chemical structure of chitosan is a copolymer consisting of β-1,4-linked 2-acetamido-D-glucose and β-1,4-linked 2-amino-D-glucose units as shown below:

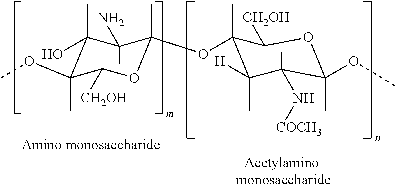

The physical, chemical and biological properties of chitosan are governed mainly by two factors: molecular weight and degree of deacetylation (DD=m/(m+n)). Chitosan can not dissolve in water, yet soluble in dilute acidic solution (i.e. pH<6.3) whereas its amino groups are converted from —NH₂ to —NH₃⁺, in the form of cationic polyelectrolyte.

There are three models have been speculated on the mechanism of chitosan inhibiting and killing microorganisms. The most acceptable proposes that positively-charged chitosan molecules interact with the negatively charged microbial cell wall, by the electrostatics forces upon encounter. The electrostatics interaction results in two interferences. First, the change in permeability of the cell wall, thus causing internal osmosis imbalances and consequently inhibits the growth of microorganisms. Second, the hydrolysis of the peptidoglycan in cell wall leads to the leakage of intracellular electrolytes. The second mechanism proposes that smaller chitosan molecules are able to pass through the microbial cell wall. The small molecules enter the nuclei to interrupt DNA transcription to RNA which in turn disrupts protein synthesis. The third mechanism proposes that chitosan exhibits chelation with metals, thus suppress the growth factors of spores elements and binds to the essential nutrients for microbial growth, contributing to cell death.

These three proposed mechanisms have been confirmed experimentally. Many studies showed that the microbicidal activity of chitosan depended on its molecular weight and degree of deacetylation significantly. The amino group —NH₂ is involved in the electrostatic interaction and the chelation. Evidently, the DD acts as an internal factor to determine the functionality of amino groups while the conjugated acid and pH value are external factors. The experimental results have also shown that chito-oligosaccharide is more effective than chitosan polymer, on the reducing of microorganism growth. It has been suggested that the influence of molecular weight on the microbicidal efficacy is greater than the influence of DD.

Chitosan has been made a variety of antimicrobial formulations and incorporated in different types of products including fibers, films and composite structures. Nevertheless, the inhibition rate of microbe growth by chitosan is relatively slow and is therefore categorized as an antimicrobial. Chitosan does not conduct disinfection rapidly and lacks efficacy toward viruses, thus failing to serve as a sanitizer.

Peroxycarboxylic acid is a product prepared by the per-hydrolysis of carboxylic acid with hydrogen peroxide which is a reversible oxidation. That is to say, the reverse reaction will occur when the peroxycarboxylic acid is dissolved in water, thus resulting in oxidative ability and yielding hydrogen peroxide and carboxylic acid. Specifically, peroxycarboxylic acid is reduced and converted back to the starting material, finally breakdown into O₂, CO₂ and H₂O. Peroxycarboxylic acid is widely used in industry for sanitization, bleaching or synthesis of fine chemicals.

RCO₂H+H₂O₂ [symbol] RCO₃H+H₂O

Peroxycarboxylic acid kills microbes by oxidation mechanism, whereas electrons are transferred to microorganisms. Therefore, the stronger the oxidizer, the faster electrons are transferred to the microorganism and the faster the microorganism is inactivated or killed. Take peroxyacetic acid (PAA) for example. PAA has a higher oxidation potential (1.81 eV) than sodium hypochlorite (1.36 eV). PAA is rapidly active at low concentrations against a wide spectrum of microorganism including bacteria, fungi and viruses. It does not leave toxic decomposition products, but forms water-soluble products. PAA has been recognized as a safe sanitizer by WHO, US FDA and US EPA and used in medicine, food, and normal household.

Peroxycarboxylic acid, hydrogen peroxide and water are the fundamental components for making sanitizers containing peroxycarboxylic acid. Additional supplements are added to make a composition. Bowing et al (U.S. Pat. No. 4,051,058 and U.S. Pat. No. 4,051,059) added organic phosphonic acid to capture metal ions. Also, anionic surfactants of sulfate or sulfonate were added to increase stability. Crommelynck et al (U.S. Pat. No. 4,297,298) added trace of strong acid to increase stability. Jourdan-Laforte et al (U.S. Pat. No. 4,587,264) added nitric acid to achieve non-corrosion. Casentino et al (U.S. Pat. No. 5,508,046 and U.S. Pat. No. 5,656,302) utilized phosphonic acids and sodium pyrophosphate and added divalent or trivalent metal ions to increase stability. Melone et al (U.S. Pat. No. 5,720,983) utilized alkali metal phosphate such as dipotassium hydrogen orthophosphate as corrosion inhibitor. Smith et al (US2004/0143133) added amino oxide to reduce odor.

Regarding the combination of peroxycarboxylic acid and chitosan, conventional technique uses peroxycarboxylic acid as an oxidant to produce oxidized chitosan, reduce the viscosity of the chitosan or adjust the pH value. Eoff et al (U.S. Pat. No. 6,764,981, U.S. Pat. No. 6,981,552 and U.S. Pat. No. 7,007,752) disclosed that oxidized chitosan can be used in well treatment. Peracetic acid is used to oxidize or degrade chitosan-based polymer and yields chitosan exhibiting higher solubility and low viscosity. Wick et al (U.S. Pat. No. 6,794,346) disclosed a combination of chitosan and furanone as detergent. To optimize the effectiveness of chitosan and furanone the pH value should be below 6.0 by using lactic acid, sulfamic acid, citric acid, valeric acid, hexanoic acid and glycolic acid. Peracetic acid was also mentioned as a preferred acid. Avery et al (U.S. Pat. No. 6,849,586) disclosed a cleaning composition of chitosan and other (organic or inorganic) microbicides. To exert the desired antimicrobial effect, organic acids were used to adjust the water solution to pH<7.0. Peracetic acid was mentioned again among a selection of organic acids.

Current trend does not solely combine peroxycarboxylic acid and chitosan to provide microbicidal effect. The aforementioned patented formulation (U.S. Pat. No. 6,794,346 and U.S. Pat. No. 6,849,586) utilized chitosan, acids and other microbicides as essential components. The introduction of other microbicides in addition to peroxycarboxylic acids and chitosan is bond to raise safety concerns and limit the applicable fields. Narciso et al (J. A. Narciso, E. A. Baldwin, A. Plotto, and C. M. Ference, Preharvest Peroxyacetic Acid Sprays Slow Decay and Extend Shelf Life of Strawberries, Hort Science 42(3):617-621. 2007) sprayed peroxyacetic acid on strawberries before harvest and soaked the strawberries in chitosan solution after harvest. Microbes were effectively removed and freshness was maintained as well. Peroxycarboxylic acid and chitosan were used in two separate steps which compromise the convenience and increase the cost.

To address the above issues, the inventor strives via associated experience and research to present the instant disclosure, which can effectively improve the limitation described above.

### SUMMARY OF THE INVENTION

The instant disclosure is to provide a disinfecting composition of chitosan and peroxycarboxylic acid, which is effective at facilitating microbicidal activity and stain removal. A preferable composition has chitosan to peroxycarboxylic acid by weight ratio (w/w) ranging from 0.01 to 100. Chitosan is selected from the group consisting of amino monosaccharide, acetylamino monosaccharide, chitooligosaccharide, chitosan polymer and the combination thereof. Peroxycarboxylic acid is the C1-C18 aliphatic peroxycarboxylic acid selected from the group consisting of peroxy monocarboxylic acids, peroxy dicarboxylic acids and the combination thereof. The composition can be diluted to a working solution having more than 10 ppm chitosan, applied in disinfection.

In order to further understand the instant disclosure, the following embodiments are provided along with illustrations to facilitate the appreciation of the instant disclosure; however, the appended drawings are merely provided for reference and illustration, without any intention to be used for limiting the scope of the instant disclosure.

### BRIEF DESCRIPTION OF THE DRAWINGS

FIG. 1 is a flow chart showing a disinfection process on an object surface by a disinfecting composition in accordance with the instant disclosure.

FIG. 2A is a schematic diagram showing a disinfection process on an object surface by a disinfecting composition in accordance with the instant disclosure.

FIG. 2B is a schematic diagram showing a disinfection process on an object surface by a disinfecting composition in accordance with the instant disclosure.

FIG. 2C is a schematic diagram showing a disinfection process on an object surface by a disinfecting composition in accordance with the instant disclosure.

### DETAILED DESCRIPTION OF THE PREFERRED EMBODIMENTS

The aforementioned illustrations and following detailed descriptions are exemplary for the purpose of further explaining the scope of the instant disclosure. Other objectives and advantages related to the instant disclosure will be illustrated in the subsequent descriptions and appended drawings.

The instant disclosure relates to a disinfecting composition derived from chitosan. Furthermore, the combination of chitosan and peroxycarboxylic acid promotes the microbicidal efficacy. The preferable weight ratio (w/w) of chitosan to peroxycarboxylic acid ranges from 0.01-100.

The instant disclosure adapts edible natural source: chitosan as one of the main components of the microbicidal composition. The chemical constituents of chitosan are non-toxic and chitosan is recognized by USEPA as a safe antimicrobial. The other main component is peroxycarboxylic acid, which is a USEPA-recognized safe microbicide. Peroxycarboxylic acids will convert into carboxylic acids and form salts with chitosan and therefore leaves no toxic material behind.

Chitosan is a natural polysaccharide whose long chain includes two moieties: amino monosaccharide and acetylamino monosaccharide. The moieties exhibit excellent film forming ability and suppress microbe growth. Chitosan is not water soluble but it dissolves in the aqueous solutions of certain organic and inorganic acid. The molecular weight and degree of deacetylation of chitosan determine the properties of film formation. The film forming ability is also restricted by the properties of the acid molecules in the solution. Given the chitosan of the same chemical structure, a stronger film can be made by using a better soluble acid to chitosan. Reaction I shows the chemistry of chitosan dissolving in aqueous acid: the amino group (—NH₂) of the chitosan receives a free proton (H⁺) in water and coverts to —NH₃⁺, leading to dissolution.

—NH₂+H⁺+A⁻→—NH₃⁺+A⁻ (I)

The instant disclosure utilizes peroxycarboxylic acid and chitosan as the components of the microbicidal composition. Peroxycarboxylic acid and its decomposed products (carboxylic acid) can be dissociated and release proton H⁺ in the water as shown in Reaction II. Therefore peroxycarboxylic acid enhances chitosan solubility and stabilizes the solution to obtain reliable film formation.

RCO₃H [symbol] RCO₃⁻+H⁺

RCO₃H+H₂O [symbol] RCO₂H+H₂O₂

RCO₂H [symbol] RCO₂⁻+H⁺ (II)

In other words, the function groups of the two main components, peroxycarboxylic acid (R—CO₃H) and chitosan (Ch-NH₂), form an ion pair, which are compatible in water and obtain a stable solution as shown in Reaction III.

Ch-NH₂+R—CO₃H→Ch-NH₃⁺+RCO₃⁻ (III)

The microbicidal efficacy of chitosan depends on the intrinsic characteristics of chemical structure: degree of deacetylation and molecular weight. External factors including conjugated acids and pH values are also involved. As shown in Reactions II and III, peroxycarboxylic acid and the corresponding carboxylic acids along with free protons H⁺ are in equilibrium. The system of conjugated acids and the pH condition offer an appropriate environment to facilitate microbicidal activity of chitosan. In other words, the composition consists of chitosan and peroxycarboxylic acid, these two components exhibit excellent stability and synergistically microbicidal activity.

The instant disclosure is further elaborated herein by an embodiment but not limited thereto. The chitosan is selected from the group consisting of amino monosaccharide, acetylamino monosaccharide, chitooligosaccharide, chitosan polymer and the combination thereof. Experimental results have shown that chitooligosaccharide exhibits better microbicidal ability than chitosan polymer. In addition, molecular weight plays more important role in microbicidal function than the degree of deacetylation. Chitooligosaccharide is the product of depolymerization of chitosan. There are three ways to depolymerize chitosan macromolecules: chemical hydrolysis, physical scission or enzymatic degradation. Enzymatic method utilizes chitosanase or protease to degrade chitosan macromolecular chain and obtain chitooligosaccharide. Physical method utilizes ultrasonication or irradiation to downsize chitosan macromolecule. Chemical method undergoes acidic hydrolysis or oxidative degradation to cleave the main chain of chitosan macromolecules and obtain chitooligosaccharide, the low-molecular-weight chitosan. The oxidative degradation can use peroxides, sodium nitride or ozone as the oxidant which may take action on two possible positions of the chitosan polymer chain, either on the bridge bonds between D-glucopyranose rings or function groups on the rings. Upon acting on the bridge bonds, the chitosan structural units remains unchanged while the main chain length reduces, known as degradation. Upon acting on the ring, it proceeds with the side reactions of the degradation including ring-opening, carboxylation and loss of amino group which are known as the decomposition. When using oxidants to conduct oxidative degradation, it may inhibit side reactions and obtain chitooligosaccharide by controlling the reaction conditions for example reactant concentration, reaction temperature, pH value and reaction time.

In the instant disclosure, the peroxycarboxylic acid is a C1-C18 aliphatic peroxycarboxylic acid selected from the group consisting of peroxy monocarboxylic acid, peroxy dicarboxylic acid and the combination thereof. Peroxycarboxylic acids generate carboxylic acids and hydrogen peroxide in aqueous solution and reach chemical equilibrium. The peroxycarboxylic acid and hydrogen peroxide are oxidants providing oxidative function. The oxidants facilitate chitosan oxidative degradation and promote the microbicidal activity. The present invention provides a disinfecting composition in which the concentration and applied ratio of chitosan and peroxycarboxylic acid as well as the mixing time, temperature and methods etc. may be adjusted accordingly to meet intended purposes. The solubility and viscosity can be altered thereby for preferable microbicidal composition. Preferably, the microbicidal composition contains 0.01-30% (w/w) C1-C18 carboxylic acid, 0.01-30% (w/w) hydrogen peroxide or both. The carboxylic acid is selected from the group consisting of formic acid, acetic acid, propionic acid, octanoic acid, capric acid, lactic acid, glutaric acid, adipic acid, sebacic acid, citric acid, malic acid, maleic acid, gluconic acid, amino acid and the combination thereof.

The disinfecting composition can be diluted by diluent to a solution having more than 10 ppm chitosan. The diluted solution is a homogeneous solution. Specifically, the composition is completely water soluble and therefore when the chitosan concentration locates in the range of 10 ppm-10% (w/w), the composition can be preserved stably in aqueous solution for more than 6 months. Furthermore, when spraying the aqueous composition on an object surface, water and other gaseous molecules are evaporated whereas the protection film formed by chitosan remains thereon. As shown in Reaction IV, The composition performs the microbicidal activity on an object surface where the peroxycarboxylic acid releases carboxylic anion (RCO₂⁻) and free oxygen ([O]). The free oxygen is used to execute fast microbicidal activity and the carboxylic anion (RCO₂⁻) leaves behind and forms chitosan salt (Ch-NH₃⁺. . . ⁻O₂CR) with chitosan cation (Ch-NH₃⁺), which composes the protection film. That is to say the disinfecting composition carries on functioning as a long-lasting microbicide as shown in Reaction V.

RCO₃⁻→RCO₂⁻+[O] (IV)

Ch-NH₃⁺+RCO₂⁻→Ch-NH₃⁺ . . . ⁻O₂CR (V)

In short summary, the disinfecting composition can be formulated into aqueous solution or emulsified dispersion for desired concentration and sprayed on hard or soft surface. The composition forms a microbicidal protection film on the object surface to achieve disinfection and stain removal. In addition, the formulation parameters for example, the concentration and ratio of chitosan and peroxycarboxylic acid, as well as preparation procedure, mixing time, and temperature can be altered to meet intended purpose and improve the protection film effectiveness.

The disinfectant, the composition of chitosan and peroxycarboxylic acid, can be stored in liquid form for microbicidal usage. In order to extend the shelf life of the composition, supplemental ingredients can be added to enhance stability. For a given compound to be a stabilizer, the primary requirement is that the addition should not affecting the microbicidal efficacy, it may be added in the formulation by passing through the compatible assessment and dosage test. The said compounds or stabilizers exhibit the capability of stabilizing peroxide. Preferably, the stabilizer concentrates in the range of 10 ppm-10% by weight of component. Also, the stabilizer can be selected from the group consisting of stannate, pyrophosphate, silicate, sulfate, sulfonate and the combination thereof. The stabilizer can regulate the dissociation of peroxycarboxylic acid releasing the proton H⁺ and further facilitate chitosan exerting superiorly microbicidal activity. Additionally, the stabilizer leads chitosan molecules stably dissolved in the solution containing peroxycarboxylic acid, hydrogen peroxide and free proton H. In general, the stabilizer elevates chitosan solubility and helps the composition to achieve preferable film formation on the object surface.

On the other hand, the composition exhibits oxidative nature and therefore its application may lead to corroding metallic objects. Anticorrosive ingredients may also be added to the composition to avoid the risk of corrosion when the disinfection takes long contact with metals. In other words, anticorrosive additives can be introduced into disinfectant formulations on condition that the addition does not adversely affect microbicidal activity, adopted by the compatibility test. The test results have showed that the effective dosage of anticorrosive additives is in the range from 10 ppm-10% (w/w) in the microbicidal composition. The anticorrosive compound is selected from the group consisting of nitric acid and nitrate, phosphoric acid and phosphate, phosphonic acid and phosphonate, hypophosphorous acid and hypophosphate, the salts of alkali metal, divalent or trivalent metal ions, and the combination thereof. Specifically, the anticorrosive ingredients are used to adjust the corrosion capability of peroxycarboxylic acid.

Further still, surfactants can be added to the microbicidal composition to improve the wetting ability, permeability, foaming property and stability and thus enhance the overall microbicidal activity as applied in disinfection and protecting material. For example, by adding 0.1-20% (w/w) of surfactant, it can increase the solubility and stability of microbicidal liquid and improve the protection-film formability, covering and adhesion unto materials against microbes. Alternatively, when 1-99% (w/w) surfactant is added to the microbicidal composition, the formulation can be prepared as a multi-functional detergent for cleaning, sterilization, and protection.

In conclusion, the disinfecting composition including peroxycarboxylic acid and chitosan is a safe microbicide because these two major components do not exhibit toxicity. Peroxycarboxylic acid exhibits fast microbicidal activity while chitosan exhibits longer-term microbicidal durability and excellent film formation. Peroxycarboxylic acid and chitosan are highly compatible and complement each other in function to form a safe, convenient and effective microbicide. In addition, the formulations of peroxycarboxylic acid and chitosan are quite reliable and stable. The cooperative microbicidal activity enhances the overall microbes killing efficacy.

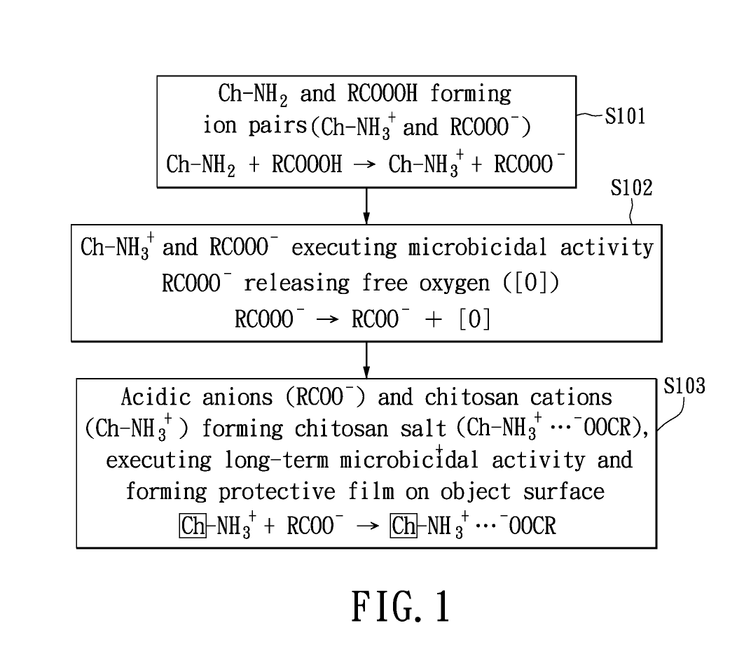

Please refer to FIG. 1. The process of the microbicidal composition exerting functions include step S101, step S102 and step S103.

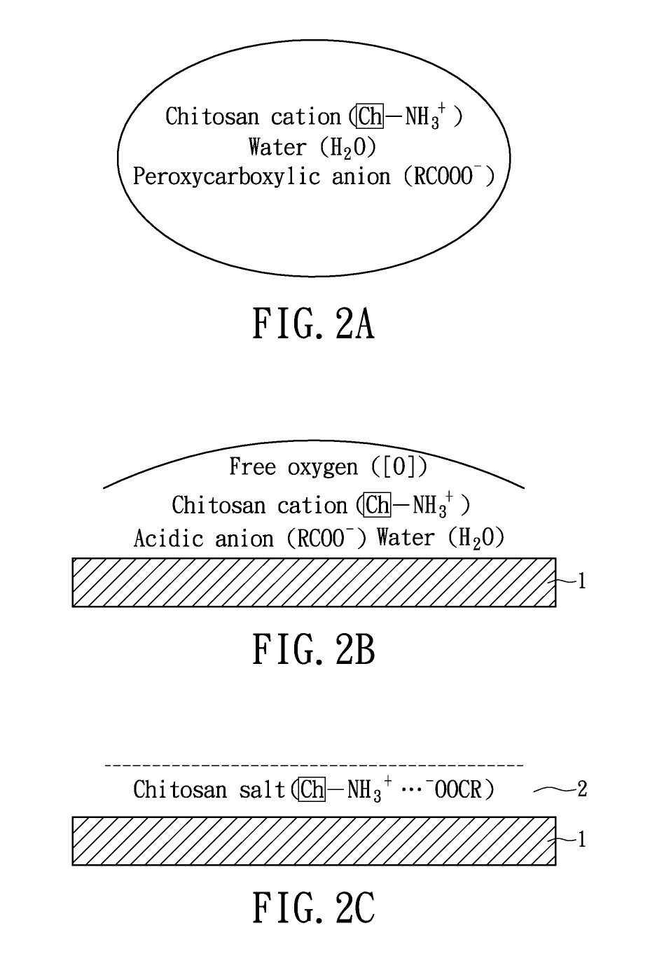

Please refer to FIGS. 2A to 2C. FIG. 2A is a schematic diagram showing the microbicidal composition exerting microbe removal. FIG. 2B is another schematic diagram showing the microbicidal composition exerting microbe removal. FIG. 2C is yet another schematic diagram showing the microbicidal composition exerting microbe removal. Note that FIGS. 2A to 2C show the idea mode of the instant disclosure. As shown in FIG. 2A, chitosan (Ch-NH₂) and peroxycarboxylic acid (RCOOOH) exist as ion pairs, cationic chitosan (Ch-NH₃⁺) and peroxycarboxylic anion (RCOOO⁻), in a homogenous system (step S101). Subsequently, as shown in FIG. 2B, the microbicidal composition executes microbicidal activity by two active components, peroxycarboxylic anion (RCOOO⁻) and chitosan cation (Ch-NH₃⁺), whereas the former releases free oxygen ([O]) to kill microbes (step S102). Then, as shown in FIG. 2C, the microbicidal composition forms a protection film covering up the object surface. Peroxycarboxylic anion (RCOOO⁻) releases oxygen and converts to carboxylic anion (RCOO⁻) which interacts with cationic chitosan (Ch-NH₃⁺) forming a complex (Ch-NH₃^{+ -}OOCR). The chitosan carboxylic salt (Ch-NH₃^{+ -}OOCR) continuously provides microbicidal activity for a long term disinfection (step S103).

To further elaborate the instant disclosure, associated results from an embodiment are discussed herein. Chitosan was the product of crab-shell processing, obtained from the same batch. The molecular weight of chitosan ranged from 100,000-150,000 and the degree of deacetylation was approximately 86%. Peroxyacetic acid (PAA) was a reagent purchased from Sigma Aldrich. Octave™ from Ecolab Inc. was used as peroxyoctanoic acid (POA).

### Embodiment 1

In a 1 L beaker, 50 g of PAA was added and water was added to dilute. The total weight of PAA and water reached 950 g then 50 g of chitosan was added. The mixture containing 5% chitosan, 1.6% CH₃COOOH was stirred at room temperature for 5 hours. When the stirring was finished, the mixture was left standing at room temperature for 24 hours. In another 1 L beaker, 50 g of Octave™ was added and water was added to dilute. When the total weight of Octave™ and water reached 925 g, 50 g of chitosan and 25 g of glacial acetic acid (AA) were added. The mixture containing 5% chitosan, 4.7% POA and 2.5% AA was stirred at room temperature for 5 hours, and then was left standing for 24 hours to obtain a homogenous solution. In addition, a reference sample of no peroxycarboxylic acid was prepared which contained 5% chitosan, 2.5% acetic acid and the balance water. In 925 g water, 25 g AA and 50 g chitosan were added and stirred at room temperature for 5 hours. After stirring, the mixture rested at room temperature for 24 hours to obtain homogenous solution. Microbicidal activity and viscosity of these three samples were tested and measured. The viscosity was measured by Broofield viscometer at 20° C. The results are shown in Table 1.

TABLE 1

| Sample | Chitosan | Peroxycarboxylic acid | Acetic acid | Viscosity | |
|---|---|---|---|---|---|
| A | 5% | — | 2.5% | 32000 | cp |
| B | 5% | 5% PAA | — | 600 | cp |
| C | 5% | 5% Octave | 2.5% | 850 | cp |

Minimum Inhibitory Concentration Test (MIC) was conducted to determine the microbicidal effectiveness. Escherichia coli and Aspergillus niger were employed as test microorganisms. Each sample was diluted to 6 sub-samples by suitable medium, in which the chitosan concentrations were 500, 250, 100, 75, 50 to 25 ppm by weight. The diluent samples were split into two groups inoculated with E. coli and A. niger respectively. Samples having E. coli were incubated at 37° C. for 24 hours and then were inspected the growth status. Samples having A. niger were incubated at 28° C. for 15 days. The results are shown in Table 2.

TABLE 2

| | | MIC (concentration of chitosan) | | | | | |
|---|---|---|---|---|---|---|---|
| Sample | Strains | 25 ppm | 50 ppm | 75 ppm | 100 ppm | 250 ppm | 500 ppm |
| A | E. coli | + | + | + | + | − | − |
| B | E. coli | + | − | − | − | − | − |
| C | E. coli | + | − | − | − | − | − |
| A | A. niger | + | + | + | + | + | − |
| B | A. niger | + | − | − | − | − | − |
| C | A. niger | + | + | − | − | − | − |

(+): growth,
(−) inhibition

### Embodiment 2

The bactericidal effectiveness of disinfectants was evaluated for the microbicidal composition containing stabilizer and anti-corrosion agent. Sample D was prepared in a 1 L beaker which contained 10 g chitosan, 10 g PAA, 2 g phosphonic acid (RPO(OH)₂), 5 g dipotassium hydrogen orthophosphate (K₂HPO₄) and water to reach a total weight of 1000 g. After stirring at room temperature for 5 hours, the mixture was left standing for 24 hours to obtain homogenous solution.

Sample D was tested under the guideline of AOAC 960.09 (Germicidal and Detergent/Sanitizing Action of Disinfectants) for evaluating microbicidal activity. Staphylococcus aureus and Escherichia coli were employed as target organisms. Sample D was diluted 100 times to a concentration of 100 ppm chitosan by using AOAC standard hard water. The following test procedure was used: 1 ml of a test organism suspension was added to 99 ml of diluted test sample which was placed in a constant temperature bath of 20° C. Shake the mixture thoroughly, the number of bacteria present in the test system was determined after 30 sec and 60 sec contact time. The colony forming units were counted by the procedures as follows: ten-fold serial dilution, plate inoculation and incubation for 48 hours at 37° C. Initial numbers control was performed by adding 1 ml of the appropriate test organism to 99 ml of the sterile phosphate buffer dilution. The number of bacteria present in the control system was determined after 30 sec, by following ten-fold serial dilution, plate inoculation and incubation for 48 hours at 37° C. The numbers control were obtained by counting plates to be S. aureus=5.8×10⁷CFU, and E. coli=6.3×10⁷CFU. The test results are shown in Log Reduction in Table 3.

TABLE 3

| Sample | Organism | Contact time | CUF | Log₁₀ Reduction |
|---|---|---|---|---|
| D | S. aureus | 30 sec | 8.0 × 10² | 4.86 |
| D | S. aureus | 60 sec | <100 | >5.76 |
| D | E. coli | 30 sec | <100 | >5.80 |
| D | E. coli | 60 sec | <100 | >5.80 |

CFU: colony forming units.

### Embodiment 3

Sample E includes 10 g chitosan, 5 g Octave™, 5 g glacial acetic acid, 3 g phosphonic acid, 7 g K₂HPO₄ and 970 g water. The preparing method was the same as Sample D.

Sample E was tested under the guideline of AOAC 960.09 (Germicidal and Detergent/Sanitizing Action of Disinfectants) for evaluating microbicidal activity. Staphylococcus aureus and Escherichia coli were employed as target organisms. Sample E was diluted 100 times to a concentration of 100 ppm chitosan by using AOAC standard hard water. The following test procedure was the same as Sample D used. The test results are shown in Log Reduction in Table 4.

TABLE 4

| Sample | Organism | Contact time | CUF | Log₁₀ Reduction |
|---|---|---|---|---|
| E | S. aureus | 30 sec | 7.5 × 10³ | 3.88 |
| E | S. aureus | 60 sec | 4.1 × 10² | 5.14 |
| E | E. coli | 30 sec | 2.3 × 10⁴ | 3.44 |
| E | E. coli | 60 sec | <100 | >5.80 |

CFU: colony forming units.

In summary, the instant disclosure provides the disinfecting composition including peroxycarboxylic acid and chitosan, which are safe and environmentally friendly disinfectants. Peroxycarboxylic acid exhibits broad and fast microbicidal activity while chitosan exhibits long term microbicidal durability and excellent film formation. These two major components complement each other in function to form a safe, convenient and effective microbicide. Peroxycarboxylic acid lead chitosan completely dissolved in aqueous system, which are highly compatible and the formulation is quite reliable and stable. The combination of peroxycarboxylic acid and chitosan provides cooperative effects in microbicidal effectiveness. In addition, the formulation of peroxycarboxylic acid and chitosan is made by one-step mixing procedure to form a stable microbicide without additional active ingredients Thus the instant disclosure provides an efficient manufacturing method with low cost. The microbicidal composition can also be diluted to a desired concentration in water for spraying on soft or hard surface. The composition sanitizes or disinfects the material surface and removes the contaminated stain at the same time. The microbicidal composition also forms the protection film covering on the object surface to avoid further microbe invasion.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A disinfecting composition comprising:
chitosan; and
peroxycarboxylic acid;
wherein the weight ratio of chitosan to peroxycarboxylic acid is from 0.01 to 100, chitosan is selected from the group consisting of amino monosaccharide, acetylamino monosaccharide, chitooligosaccharide, chitosan polymer and the combination thereof, and peroxycarboxylic acid is a C1-C18 aliphatic peroxycarboxylic acid that is selected from the group consisting of peroxy monocarboxylic acid, peroxy dicarboxylic acid and the combination thereof.

2. The disinfecting composition according to claim 1 further comprising 0.01-30 wt % hydrogen peroxide.

3. The disinfecting composition according to claim 1 further comprising 0.01-30 wt % C1-C18 carboxylic acid.

4. The disinfecting composition according to claim 3, wherein the carboxylic acid is selected from the group consisting of formic acid, acetic acid, propionic acid, octanoic acid, capric acid, lactic acid, glutaric acid, adipic acid, sebacic acid, citric acid, malic acid, maleic acid, gluconic acid, amino acid and the combination thereof.

5. The disinfecting composition according to claim 1 further comprising 0.01-30 wt % hydrogen peroxide and 0.01-30 wt % C1-C18 carboxylic acid.

6. The disinfecting composition according to claim 5, wherein the carboxylic acid is selected from the group consisting of formic acid, acetic acid, propionic acid, octanoic acid, capric acid, lactic acid, glutaric acid, adipic acid, sebacic acid, citric acid, malic acid, maleic acid, gluconic acid, amino acid and the combination thereof.

7. The disinfecting composition according to claim 1 further comprising 10-1000 ppm or 0.1-10 wt % of a stabilizer for stabilizing peroxides.

8. The disinfecting composition according to claim 7, wherein the stabilizer is selected from the group consisting of stannate, pyrophosphate, silicate, sulfate, sulfonate and the combination thereof.

9. The disinfecting composition according to claim 1 further comprising 10-1000 ppm or 0.1-10 wt % of an anticorrosion compound.

10. The disinfecting composition according to claim 9, wherein the anticorrosion compound is selected from a group consisting of nitric acid, nitrate, phosphoric acid, phosphate, phosphonic acid, phosphonic acid, phosohonate, hypophosphorous acid, hypophosphite, alkali metal ions, divalent metal ions, trivalent metal ions and the combination thereof.

11. The disinfecting composition according to claim 1 further comprising 0.1-20 wt % of surface active agents.

12. The disinfecting composition according to claim 1 further comprising 1-99 wt % of a surface active agent.
